(19) United States
(12) Patent Application Publication
(10) Pub. No.: US 2016/0077022 A1
(43) Pub. Date: Mar. 17, 2016

(54) METHOD AND DEVICE FOR MEASURING DEPOSITS IN THE INTERIOR OF AN APPARATUS BY USING MICROWAVE RADIATION

(71) Applicant: BASF SE, Ludwigshafen (DE)

(72) Inventors: Steffen WAGLÖHNER, Bad Schönborn (DE); Ingolf HENNIG, Neulußheim (DE)

(21) Appl. No.: 14/785,971

(22) PCT Filed: Apr. 22, 2014
(86) PCT No.: PCT/EP2014/058127

§ 371 Date: Oct. 21, 2015

(30) Foreign Application Priority Data
Apr. 23, 2013 (EP) 13164853.7
Jun. 24, 2013 (EP) 13173399.0

(51) Int. Cl. G01N 22/00

(52) U.S. Cl. CPC G01N 22/00

(57) ABSTRACT

The invention relates to a method for measuring deposits in the interior (12) of an apparatus (10) by using microwave radiation, comprising the steps

a) arranging at least one microwave resonator (20) in the interior (12) of the apparatus (10), wherein the interior (36) of the microwave resonator (20) is connected to the interior (12) of the apparatus (10) such that an exchange of material can take place, or forming the interior of the apparatus (10) as at least one microwave resonator (20),

b) introducing microwave radiation into the at least one microwave resonator (20) and

c) determining a resonant frequency and/or a quality of a resonance of the at least one microwave resonator (20) ,

wherein the steps b) and c) are repeated and, from a change in the resonant frequency and/or the quality of a resonance of the at least one microwave resonator (20), conclusions are drawn about the quantity and/or type of deposits in the interior (12) of the apparatus (10).

Furthermore, the invention relates to a device for carrying out the method.

The invention relates to a method for measuring deposits in the interior of an apparatus by using microwave radiation. Furthermore, the invention relates to a device for carrying out the method.

When carrying out many chemical methods and processes, undesired deposits are produced in the apparatus used, such as containers, columns, heat exchangers or reactors. If the apparatus includes a catalyst, the latter is frequently particularly affected by the undesired deposits. The deposits impair the method or the process being carried out and, depending on composition and situation, can even represent a safety problem. It is therefore necessary to remove these deposits when a specific quantity has been exceeded. For this purpose, the apparatus used must be stopped. In order to avoid unnecessary interruptions and to define the maintenance intervals in an optimal manner, it is desirable to determine the quantity and, optionally, the type of deposits.

In the case of apparatus through which flow passes, the pressure loss along the process volume can be measured for an estimation of the quantity of deposits. However, the results obtained are inaccurate and also do not permit any conclusions to be drawn as to where the deposits are located within the apparatus.

One example of a method in which deposits occur in the apparatus used is catalytic reactions of hydrocarbons, in which carbon deposits arise on the catalyst. As a result of the carbon deposits, the functioning of the catalyst is impaired, so that these carbon deposits have to be removed when they reach a specific quantity.

German patent application DE 10 358 495 A1 discloses a method for detecting the state of a catalyst, in which the interior of the catalyst housing is formed as a cavity resonator. Microwaves are injected into this cavity resonator and detected again. The loading of the stored material of the catalyst with NOx is estimated from the displacement of the resonant frequency and/or the quality of the resonator.

From the publication “Sensing the soot load in automotive diesel particulate filters by microwave methods” by Gerhard Fischerauer et al., Meas. Sci. Technol. 21 (2010), 035108, it is known that the loading of a diesel soot particulate filter with soot deposits can be measured by using microwave radiation. In this case, the particulate filter is accommodated in a part of an exhaust tube having an enlarged diameter. The tube is composed of an electrically conductive material and can serve as a waveguide for microwaves, into which microwaves are injected. The frequency of the microwaves is chosen here such that this lies below the limiting frequency of the other parts of the exhaust tube having a smaller diameter, and thus no onward transmission of the microwaves takes place. The area of enlarged diameter thus constitutes a microwave resonator, the parameters of which, such as resonances and damping, are determined. With increasing loading of the diesel soot particulate filter, the monitored parameters change, so that the loading with soot particles can be estimated.

The drawback with the methods known from the prior art for measuring deposits by using microwaves is, firstly, that, in a similar way to when measuring the pressure loss on an apparatus through which flow passes, only averaged information about the entire volume is obtained. A locally resolved measurement of the deposits in the interior of an apparatus is not possible in this way.

Secondly, the known microwave methods depend on the microwave radiation used being matched to the geometry of the container examined. The lowest critical frequency (cut-off frequency) fₖ of a cylindrical resonator in vacuum having the diameter D and open ends on both sides can be calculated by means of the formula

fₖ=c/(1.71·D)

where c designates the velocity of light. In the case of a cylindrical housing having a diameter of about 8 cm as resonator, fₖ is around 2.2 GHz and therefore in the microwave range, which usually reaches from about 1 GHz to 300 GHz. However, in many chemical processes and methods, considerably larger apparatus is used, so that if the known method is used, the resonator used would reach larger dimensions. In the case of a resonator of one meter diameter, the critical frequency is about 175 MHz and therefore lies outside the intended frequency range. In addition, the apparatus used in large technical processes is once more considerably larger, which means that the resonant frequencies are displaced to still lower frequencies. In order to detect the deposits with a sufficiently high resolution, the frequency of the electromagnetic waves injected may not be chosen to be arbitrarily low. If the dimensions of the apparatus to be examined are small enough, the method described can easily be used for measurements within this apparatus. However, direct application of the known microwave measuring methods to apparatus of any desired size is accordingly not possible.

It is an object of the invention to provide a method with which a simple determination of deposits in the interior of an apparatus is made possible. A further object of the invention is the provision of a measuring method with which deposits in the interior of an apparatus without any interruption to the process carried out therein, in a locally resolved manner and in real time, are made possible.

The object is achieved by a method for measuring deposits in the interior of an apparatus by using microwave radiation, comprising the steps
a) arranging at least one microwave resonator in the interior of the apparatus, wherein the interior of the microwave resonator is connected to the interior of the apparatus such that an exchange of material can take place, or forming the interior of the apparatus as at least one microwave resonator,
b) introducing microwave radiation into the at least one microwave resonator and
c) determining a resonant frequency and/or a quality of a resonance of the at least one microwave resonator,

wherein the steps b) and c) are repeated and, from a change in the resonant frequency and/or the quality of the resonance of the at least one microwave resonator, conclusions are drawn about the quantity and/or type of deposits in the interior of the apparatus.

In the first method step a), one or more microwave resonators are introduced into the apparatus, the interior of which is to be examined for deposits, if the interior of the apparatus cannot be used as a microwave resonator. If the interior of the apparatus is itself suitable as a microwave resonator because of the electrical conductivity of the wall and suitable dimensions, the interior of the apparatus can be formed into a microwave resonator by means of the arrangement of at least one antenna. For example, tubular apparatus or tubular parts of an apparatus, the diameter of which lies between about 1 cm and 20 cm, are suitable. This step has to be carried out only once as a preparation and can be carried out, for example, when the apparatus is out of operation in any case for cleaning or maintenance. The at least one microwave resonator comprises at least one antenna, via which microwave radiation can be introduced into the resonator, and also at least one antenna for detecting microwave radiation. It is conceivable to use the same antenna both for the introduction and for the detection of the microwave radiation. The at least one antenna is connected via a suitable cable, for example a high frequency (HF) cable or a waveguide, to a measuring instrument, which generates the microwave radiation and analyses the detected radiation.

The interior of the microwave resonator represents a defined volume, which is at least partly bounded by a conductive material. The defined volume is connected to the interior of the apparatus in such a way that an exchange of material can take place. For example, for this purpose the microwave resonator is implemented as a tube made of an electrically conductive material of defined length and diameter. The ends of the tube are open, so that a fluid flowing through the apparatus also flows through the microwave resonator. By means of suitable choice of the frequency and the mode of propagation of the microwave radiation, transmission of the radiation out of the interior of the microwave resonator into the interior of the apparatus can be suppressed, even though the resonator is not completely enclosed by an electrically conductive material.

The at least one microwave resonator is preferably designed and positioned in the interior of the apparatus so that existing fluid dynamics of the apparatus are not impaired. As a result, the introduction of the microwave resonator has no detrimental effect on the methods or processes carried out in the apparatus. If the interior of the apparatus is used directly as a microwave resonator, the fluid dynamics of the apparatus are likewise not impaired.

The materials contained in the microwave resonator, for example the fluid in the case of an apparatus through which a fluid flows, have a material-specific dielectric constant. In addition, deposits that form have a material-specific dielectric constant, which differs from that of the fluid. If, then, according to step b) of the method, microwave radiation, that is to say an electromagnetic wave, is coupled into the microwave resonator, resonances are formed, which can be detected and evaluated by the measuring instrument according to step c). Here, the resonant frequencies that occur depend on the dielectric constant of the material contained in the resonator. If deposits form in the interior of the apparatus examined, then these also form in the microwave resonator, since the latter is likewise in contact with the materials contained in the apparatus. As a result of the formation of the deposits, the material mixture contained in the microwave resonator changes, and the dielectric constant within the defined volume is also changed. This change can be detected by the measuring instrument in the form of a displacement of the resonances. Furthermore, as a rule the quality of the resonances also changes, so that the amplitude of the detected microwave radiation is also changed. From the measured changes, conclusions are then drawn about the quantity and optionally also about the type of deposits.

Under the term deposits, firstly material deposits in the interior of the apparatus are understood, secondly materials bound in the interior of the apparatus by means of adsorption, absorption or chemical conversion are also viewed as deposits in the sense of the method proposed. Both the deposition of additional material and the binding of materials lead to a measurable change in the dielectric characteristics, which can be measured with the aid of the microwave radiation.

In the interior of the apparatus, in addition to the educts and products of the method or process, filling elements, which for example contain a catalyst material, can also be introduced. In one embodiment of the method, provision is made likewise to arrange filling elements in the interior of the at least one microwave resonator. Here it is preferred to use identical filling elements.

Furthermore, it is preferably ensured that the filling of the filling elements is also identical. As a result, the same conditions are produced in the interior of the microwave resonator as in the interior of the apparatus, so that the measured results from the microwave resonator permit conclusions to be drawn about the rest of the volume in the interior of the apparatus.

In an embodiment of the invention, in step a) of the method, at least two microwave resonators are arranged distributed in the interior of the apparatus, and steps b) and c) are run through for a plurality of microwave resonators, wherein the distribution of the microwave resonators in the interior of the apparatus and the respective quantity and/or type of deposit determined are used to draw conclusions about the spatial distribution of the deposits in the interior of the apparatus.

If the interior of the apparatus is used as a microwave resonator, it is conceivable to subdivide the interior into a number of sections by introducing electrically conductive grids or meshes and to arrange at least one antenna in each section, so that a plurality of microwave resonators are likewise available.

The microwave resonators used preferably have dimensions which are of the order of magnitude of the wavelength of the microwave radiation used. In the case of frequencies between about 1 GHz and 300 GHz, this corresponds to dimensions between a few mm and about 30 cm. The microwave resonators are therefore small as compared with the apparatus examined, which as a rule has dimensions of several meters. It is thus possible for a plurality of microwave resonators to be arranged distributed within the apparatus, in order to obtain information about the spatial distribution of the deposits.

In an embodiment of the method, the apparatus is a column, a heat exchanger or a reactor,

With the method proposed, following the introduction of the at least one microwave resonator, the production of the deposits can be monitored continuously. This can be used, for example, to optimize the process parameters used to the effect that the production of the undesired deposits is prevented or at least minimized. Furthermore, in the apparatus examined, it is possible for a plurality of microwave resonators to be arranged in different positions, so that it is also possible to measure simultaneously at a plurality of different points. The spatially resolved measurement of the deposits which is possible as a result makes it possible in a straightforward way to identify problem points in the apparatus at which deposits are increasingly formed.

The measuring method proposed can be applied, for example, in catalytic methods, in which reactors are filled with catalyst fillings. The catalyst filling can consist of moldings, foams or monoliths. During the reaction of hydrocarbons, which means, for example, during hydration, dehydration or oxidation, carbon deposits are produced on the catalyst. By using the method proposed, this carbon deposition process can be quantified and localized. The running times of the reactor are advantageously lengthened since, as a result of interventions in the reaction, the formation of the carbon deposits on the catalyst contained in the reactor can be counteracted. Furthermore, the accurate data permits improved planning of the maintenance or inspections of the reactor.

A further possible application for the method is the monitoring of separation columns, in which it is possible for deposits to occur. For example, during the production of monomers such as acrylic acid, the last cleaning step can lead to high formation of polymers on the top of the column, since highly pure and non-stabilized monomers arrive there. Deposits are then produced by the self-polymerization of the monomers which occurs. By means of the continuous detection of the deposits in the separation column, the process parameters can be optimized such that the polymerization is counteracted.

Furthermore, deposits also occur in heat exchangers, which deposits can occur both in low-temperature applications and in high-temperature applications. One example of a low-temperature application is the so-called “cold boxes” in fluid catalytic cracking (FCC) processes.

During this low-temperature separation for obtaining ethylene, explosive resins, the so-called “Nox gum”, can be produced. The detection of these deposits contributes to improving the safety of the plant.

A further aspect of the invention is to provide a device for measuring deposits in the interior of an apparatus, comprising at least one microwave resonator, a microwave generator and an analysis unit, wherein the microwave resonator is designed such that, given an arrangement in the interior of the apparatus, an exchange of material between the interior of the microwave resonator and the interior of the apparatus can take place, and wherein the analysis unit is equipped to determine a resonant frequency and/or a quality of a resonance of the at least one microwave resonator and from this to draw conclusions about the quantity and/or type of deposits.

In a variant of the device, the microwave generator and the analysis unit can also form one unit and, for example, can be designed as a network analyzer or spectrum analyzer, wherein the assignment of a quantity or of a type of deposits can be made via evaluation software, which runs on a computer connected to the network analyzer.

The microwave resonator is fabricated from an electrically conductive material, it not being necessary for this to enclose the volume of the resonator completely. The dimensions of the microwave resonator are preferably of the order of magnitude of the wavelength of the microwave radiation used, which means that the dimensions lie between a few mm and about 30 cm when frequencies of about 1 GHz to 300 GHz are used.

In one embodiment of the device, the wall of the at least one microwave resonator is built up at least partly from an electrically conductive grid or an electrically conductive mesh. If use is made of an electrically conductive mesh, the quality of the resonator is determined, amongst other things, by the thickness of the mesh, the porosity, the spacing of the holes, the diameter of the holes and the shape of the holes. The diameter of the holes should preferably be below one quarter of the wavelength of the microwave radiation used, so that the latter can as far as possible not penetrate through the mesh. In this regard, see, for example, T. Y. Otoshi “RF Properties of 64-m-Diameter Antenna Mesh Material as a Function of Frequency”, JPL Technical Report 32-1526, Vol. III. In the case of an electrically conductive grid, the quality of the resonator is determined, amongst other things, by the number and arrangement of the grid bars and by the length d_{g} of the grid. Suitable arrangements are, for example, two crossed grid bars (cross grid) or four grid bars with an angle of respectively 45° to one another (star grid). Further suitable grids and their properties can be gathered, for example, from the dissertation by E. G. Nyfors “Cylindrical Microwave Resonator Sensors for Measuring Materials Under Flow”, May 2000, ISBN 951-22-4983-9, pages 131 to 146. The use of electrically conductive meshes or grids for the wall of the microwave resonator is advantageous, since an exchange of material between the interior of the microwave resonator and the rest of the interior of the apparatus is barely hampered by the mesh or the grid.

Preferably, the at least one microwave resonator of the device is designed as a cylinder resonator with circumferential surface and end faces made of an electrically conductive mesh or grid, as a cylinder resonator with a closed electrically conductive circumferential surface and end faces made of an electrically conductive mesh or grid, as a cylinder resonator with conically tapering ends, as a coaxial resonator or as a cylindrical resonator with electrically conductive fin.

In this case, the resonator outline is preferably a circular area; however, further embodiments with, for example, oval or rectangular shapes are likewise conceivable.

If the device is used in an apparatus, the interior of which is filled with filling elements, the interior of the microwave resonator should preferably likewise be filled with filling elements. In one design variant, the filling elements used can comprise a catalyst material. In order to fill the microwave resonator, use is preferably made of the same filling elements as in the remainder of the interior of the apparatus.

In an embodiment of the device, the latter comprises at least two microwave resonators, which can be arranged distributed in the apparatus, wherein the analysis unit is equipped to use the distribution of the microwave resonators and the respective type and/or quantity of the deposits determined to draw conclusions about the distribution of the deposits in the interior of the apparatus.

In this case, the determination of the quantity and/or the type of the deposits is initially carried out separately for each microwave resonator. Subsequently, during the evaluation, the positions of the respective resonators are taken into account and the distribution of the deposits in the interior of the apparatus examined is calculated.

The apparatus examined is preferably a column, a heat exchanger or a reactor.

In the cases in which the apparatus itself has suitable dimensions, so that the interior thereof can serve as a microwave resonator, it is possible to dispense with the arrangement of additional microwave resonators, and the apparatus itself can be used as a microwave resonator for the measurements.

In a further embodiment, a device for measuring deposits in the interior of an apparatus comprises a microwave generator and an analysis unit, wherein the interior of the apparatus is designed as a microwave resonator, and wherein the analysis unit is equipped to determine a resonant frequency and/or a quality of a resonance of the microwave resonator and, from this, to draw conclusions about the quantity and/or type of deposits.

The walls of the apparatus must be electrically conductive or, optionally, be made conductive by integrating a metallic layer. Here, it is sufficient if one layer of the wall is electrically conductive; it is not necessary that the inside of the wall has an electrical conductivity. In addition, the interior of the apparatus must have the dimensions required for a microwave resonator. Optionally, it is also possible for only one section of the apparatus to have the dimensions suitable for a microwave resonator. For instance, tubular apparatus or tubular parts of an apparatus, the diameter of which lies between about 1 cm and 20 cm, are suitable.

In order to use the interior of the apparatus as a microwave resonator, one or more antennas are arranged in the apparatus, at least two antennas being required for measurements in the transmission geometry. It is additionally conceivable to form more than one microwave resonator in the interior of the apparatus by arranging a plurality of antennas and subdividing the interior into a plurality of areas. The subdivision can be made, for example, with electrically conductive grids or meshes.

The use of the apparatus as a microwave resonator for the measurement of deposits in the interior of the apparatus is possible, amongst other things, in multi-tube reactors, split tubes, separation apparatus, adiabatic reactors, pilot reactors, heat exchangers, columns or pipelines.

Multi-tube reactors typically use tubes having a diameter in the range between 2 cm and 5 cm. This geometry permits the formation of microwave rays in the interior, so that the tubes can be used as microwave resonators. The application of the measuring method described previously in multi-tube reactors is expedient in particular when reactions in which disruptive deposits are formed are carried out. Multi-tube reactors are used, for example, for the production of phthalic acid anhydride (PSA), acrolein, acrylonitrile, acrylic acid, methacrylic acid, maleic acid anhydride (MSA), cyclodecanone (CDON) or olefines, dienes and alkines by oxidative dehydration (ODH).

Split tubes are used, for example, in steam crackers and usually have a diameter between 10 cm and 20 cm, so that here, too, the direct application of the microwave method for measuring deposits is possible without the introduction of additional resonators.

Furthermore, the method can be used simply in pilot reactors, which are used on a technical center scale. The dimensions thereof are likewise suitable for carrying out the method without microwave resonators additionally arranged in the interior of the reactors.

As already described in the exemplary embodiments further above, the apparatus can also be filled with filling elements or with catalysts.

In addition, separation apparatus, such as is used in the production of acrylic acid for example, has suitable dimensions for a direct application of the microwave measuring method. There, it is possible in particular for the formation of polymerisates which are formed at the top of the separation column during the production of acrylic acid, to be monitored by using the measurement.

Furthermore, many heat exchangers in the low-temperature and high-temperature range have suitable dimensions in the interior thereof for use as a microwave resonator. This includes, for example, high-temperature heat exchangers having tube diameters below 20 cm, which are used to evaporate hydrocarbon streams, it being possible for carbon deposits to occur, or heat exchangers in which biofouling occurs. In low-temperature heat exchangers, in some areas it is possible for the formation of safety-relevant deposits to occur. Examples of this are applications in the cracker sector. In the so-called cold box, in which methane and ethane are separated, nitrogen oxides present in the waste gas form explosive compounds with the hydrocarbons present. The microwave measuring technique proposed offers one possible way of detecting these deposits.

The microwave measuring technique proposed can also be used to determine the remaining capacity in guard beds. Guard beds are used to remove specific constituents from a gas mixture. For example, copper is used in a guard bed as an absorption means in order to remove sulfur compounds. As a result of the absorption of the sulfur, copper (Cu) is converted to copper sulfide (CuS). The conductivity of Cu and CuS is different, so that the microwave measuring technique can be used to determine the chemical state of the copper. The sulfur bound in the copper converted to copper sulfide is in this case viewed as a deposit to be measured.

By using the drawings, the invention will be described in more detail below.

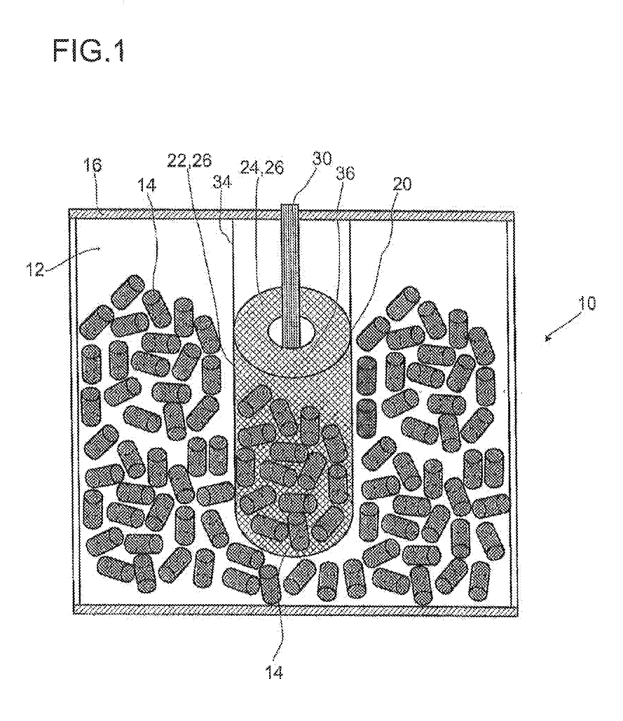

FIG. 1 shows a microwave resonator arranged in the interior of a reactor,

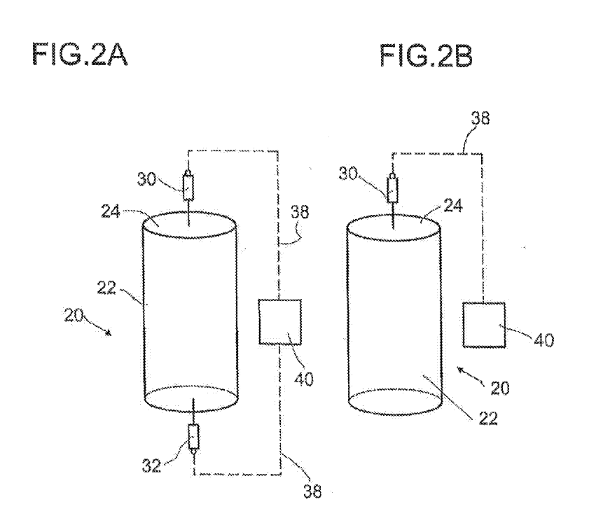

FIG. 2a shows a microwave resonator operated in transmission,

FIG. 2b shows a microwave resonator operated in reflection,

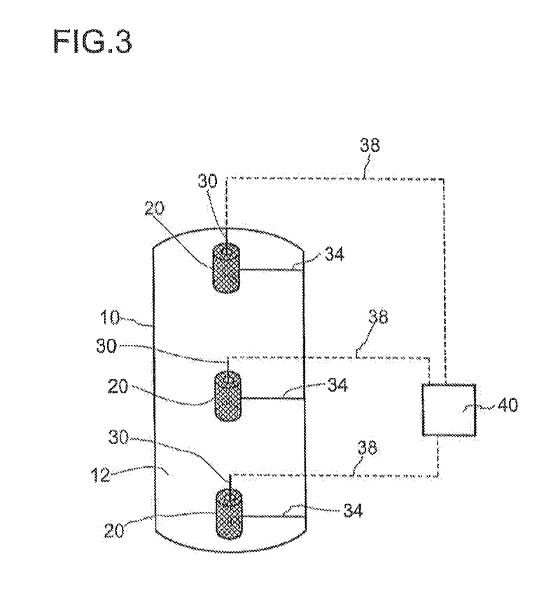

FIG. 3 shows a reactor with three microwave resonators arranged in the interior,

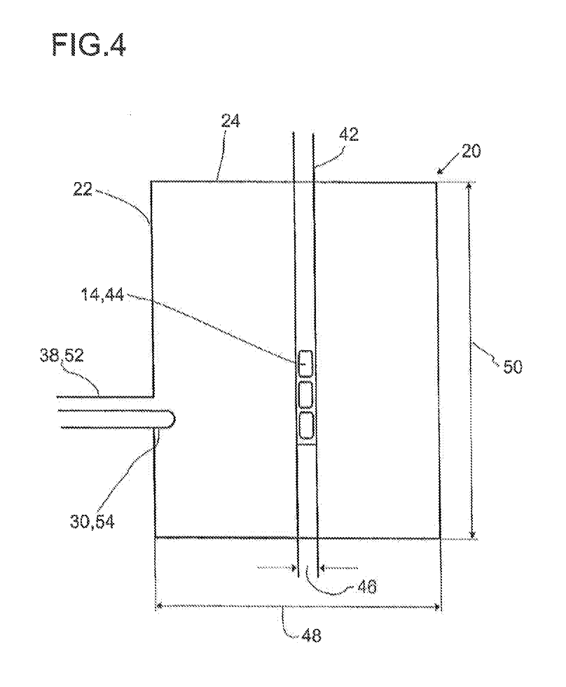

FIG. 4 shows a cylinder resonator having a capillary filled with filling elements,

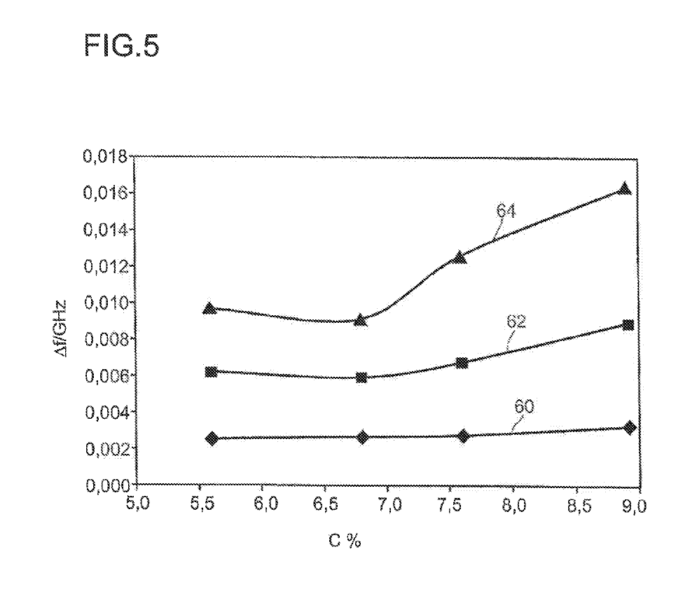

FIG. 5 shows measurement of the resonant frequency with various loadings with carbon,

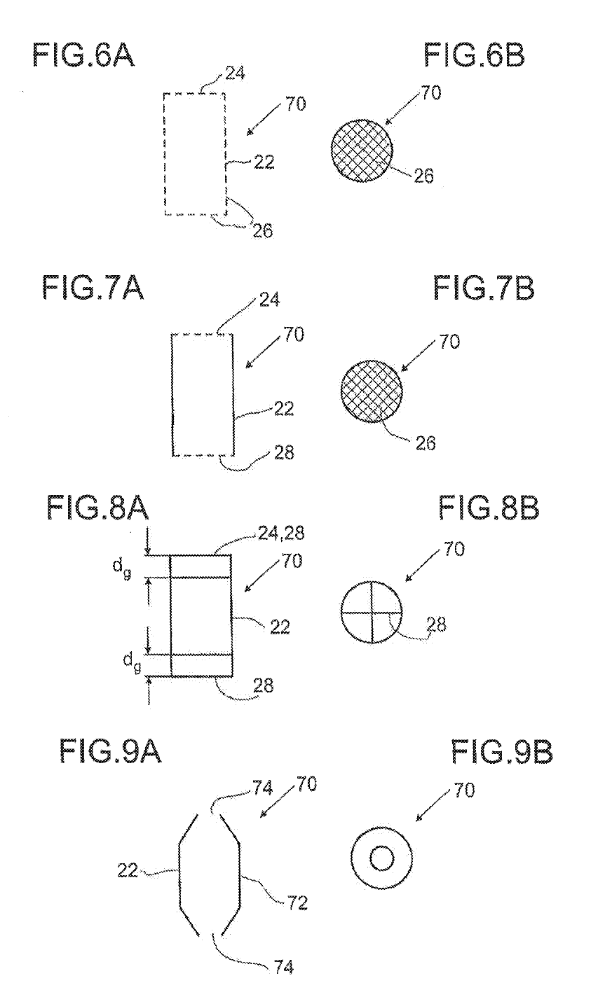

FIGS. 6a and 6b show a cylinder resonator with circumferential surface and covering surfaces made of a mesh,

FIGS. 7a and 7b show a cylinder resonator having a closed circumferential surface and covering surfaces made of a mesh,

FIGS. 8a and 8b show a cylinder resonator having a closed circumferential surface and a grid as covering surfaces,

FIGS. 9a and 9b show a cylinder resonator which tapers towards the open ends,

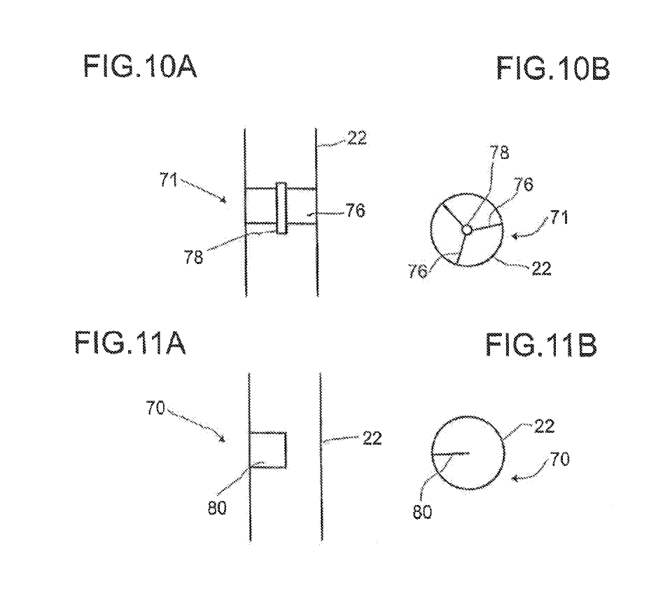

FIGS. 10a and 10b show a coaxial resonator,

FIGS. 11a and 11b show a cylinder resonator with electrically conductive fin,

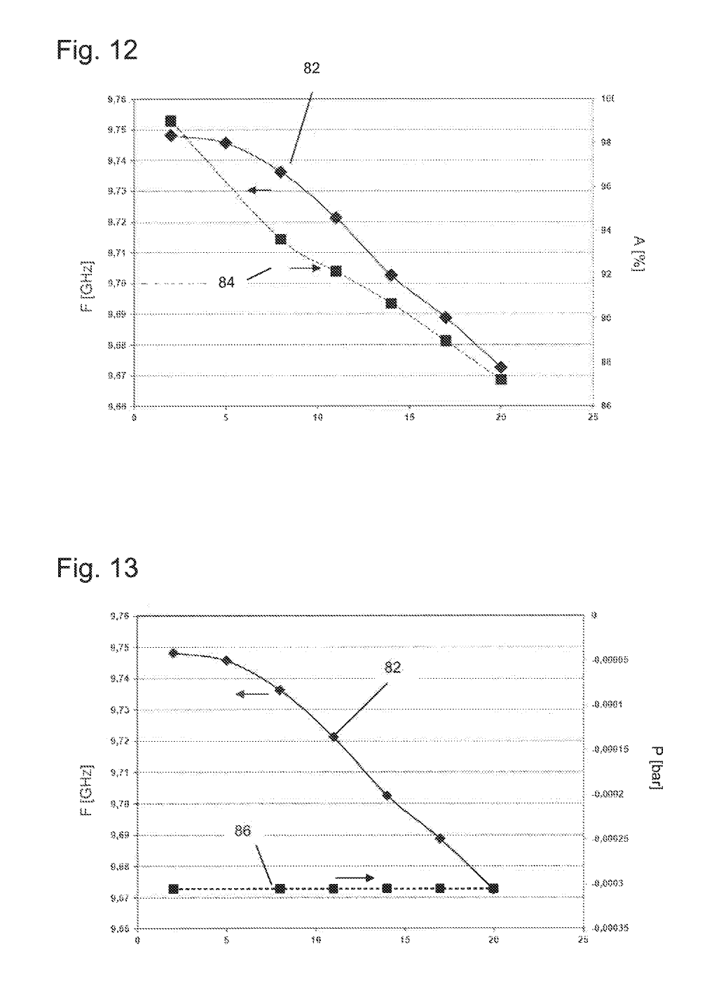

FIG. 12 shows a displacement of a resonant frequency assigned to a catalyst and a decrease in an activity of a catalyst over the operating time of a reactor and

FIG. 13 shows the pressure drop in a reactor and displacement of a resonant frequency assigned to a catalyst over the operating time of a reactor.

### EMBODIMENTS

FIG. 1 shows a microwave resonator arranged in the interior of a reactor,

FIG. 1 illustrates a container 10 of a reactor. Arranged in the interior 12 of the container 10 is a microwave resonator 20 which, in the embodiment illustrated in FIG. 1, is designed as a cylindrical resonator. The circumferential surface 22 and the end faces 24 of the microwave resonator 20 are implemented as an electrically conductive mesh 26. The microwave resonator 20 is fixed to the wall of the container 10 via a mounting 34. Both the rest of the interior 12 of the container 10 and the interior 36 of the microwave resonator 20 are filled with filling elements 14. As a result of the walls of the microwave resonator 20 being implemented as a mesh 26, an exchange of material between the interior 36 of the microwave resonator 20 and the interior 12 of the container 10 is possible without hindrance, and the conditions for the process carried out in the container 10 are largely identical in the interior 12 of the container 10 and in the interior 36 of the microwave resonator 20.

For the measurement in accordance with the method steps b) and c), an antenna 30, with which microwave radiation can be introduced into the interior 36 of the microwave resonator 20 and detected again, is provided. To this end, a measuring instrument, which firstly is able to generate microwave radiation and secondly is able to evaluate the detected radiation, is connected to the antenna 30.

To determine the resonant frequencies of the microwave resonator 20, microwaves of a specific frequency are generated by the measuring instrument and subsequently detected again via the antenna 30. This procedure is repeated for microwaves of various frequencies, the frequency range being chosen such that the latter covers the expected resonant frequency of the microwave resonator 20 and is sufficiently large to also cover a resonant frequency displaced by deposits. The frequency window which is examined is normally centered around the expected resonant frequency and is between about 10 MHz and about 1 GHz wide.

The resonant frequency determined and the amplitude of the microwave radiation detected depend on the dielectric characteristics of the materials which are located in the interior of the microwave resonator 20. Now, if deposits occur in the latter, these characteristics change and can be detected by means of the analysis of the characteristics of the microwave resonator 20, such as the resonant frequency.

FIG. 2a illustrates a microwave resonator operated in transmission,

FIG. 2a shows a microwave resonator 20 with circumferential surface 22 and end faces 24. In each case antennas 30, 32 are arranged in the areas of the end faces 24. The first antenna 30 is arranged at the top and the second antenna 32 is arranged at the bottom. The two antennas 30, 32 are connected to a measuring instrument 40 by suitable coaxial cables 38 or waveguides.

To determine the characteristics of the microwave resonator 20, the measuring instrument 40 is used to examine the behavior of the microwave resonator 20 in a predefined frequency range. The frequency window which is examined is normally centered around the expected resonant frequency and is between about 10 MHz and about 1 GHz wide. Microwaves of various frequencies are injected successively into the microwave resonator 20 by the measuring instrument 40 via the first antenna 30 and detected again via the second antenna 32. Since the microwaves pass through the microwave resonator 20 and are detected on the opposite side, the microwave resonator 20 illustrated in FIG. 2a is operated in transmission. Here, the amplitude of the radiation detected is stored for each injected frequency. By means of analyzing the maxima and minima that occur, the resonant frequencies of the microwave resonator 20 can be determined.

FIG. 2b shows a microwave resonator operated in reflection.

FIG. 2b likewise illustrates a microwave resonator 20, wherein, as distinct from the embodiment shown in FIG. 2a, only a first antenna 30 is arranged in the upper covering surface 24. The antenna 30 is connected via a feed line 38 or a waveguide to the measuring instrument 40. The measurement of the characteristics of the microwave resonator 20 is carried out in a way similar to that in FIG. 2a, but the injected microwave radiation is detected via the same antenna 30 again, so that the resonator illustrated in FIG. 2b is operated in reflection.

FIG. 3 shows a reactor having three microwave resonators arranged in the interior.

FIG. 3 illustrates a reactor 10, in the interior 12 of which three microwave resonators 20 are arranged. These are each located at different heights in the interior of the reactor 10. In the embodiment illustrated in FIG. 3, the microwave resonators 20 are implemented as cylindrical resonators, in which the circumferential surface and the end faces are built up from an electrically conductive mesh. An antenna 30, which is connected via feed lines 38 to a measuring instrument 40, is respectively arranged on the upper end faces of the microwave resonators 20. The microwave resonators 20 are fixed in the reactor 10 via mountings 34.

The respective interiors of the microwave resonators 20 are in contact with the interior 12 of the reactor 10 through the transmissive walls thereof, such that an exchange of material is possible without hindrance. If, then, deposits occur in the interior of the reactor 10, deposits will also arise in the interior of the microwave resonators 20. As already described, the deposits change the dielectric characteristics of the interior of the microwave resonators 20 as a result of their material-specific dielectric constant, and can thus be detected by the measuring instrument 40.

In addition to the detection of the deposits, by assigning the measured results to the various positions of the microwave resonators 20, the measuring instrument 40 is able to draw conclusions about the spatial distribution of the deposits in the interior of the reactor 10. This makes it possible to determine areas with particular accumulations of the deposits in a straightforward manner and therefore to identify problem areas in the apparatus used.

FIG. 4 shows a cylinder resonator having a capillary filled with filling elements.

FIG. 4 illustrates a microwave resonator 20 with circumferential surface 22 and end faces 24. The microwave resonator 20 has a height 50 of about 50 mm and a diameter 48 of about 93 mm. Arranged in the center of the microwave resonator 20 is a capillary 42, which is provided with granules 44 as filling elements 14. An antenna 30 for inductive injection 54 is arranged on the circumferential surface 22. A feed line 38 implemented as a coaxial cable 52 is connected to the antenna 30.

The resonator illustrated in FIG. 4 will be used below as an experimental set-up in order to detect the displacement of the resonant frequency with different quantities of deposits. This resonator has an accurately defined geometry and is suitable in particular for experiments.

FIG. 5 shows a measurement of the resonant frequency with the resonator according to FIG. 4 with different carbon loadings.

FIG. 5 illustrates a measurement of the resonant frequency with various carbon loadings of catalysts on the test set-up according to FIG. 4. The catalysts chosen for this measurement were commercially available catalysts in tablet form (3 mm×5 mm). These were loaded with various quantities of carbon in prior tests in a test apparatus by means of a different reaction period. The carbon loading was subsequently determined by means of element analysis. In FIG. 5, the X axis shows the loading of the catalyst elements with carbon in per cent, and the shift of the resonant frequency in GHz is plotted on the Y axis. The measurement was carried out three times, in each case with one, two or three catalyst elements in the capillary of the resonator. In the case of the measurement 60 with one catalyst element, a clearly detectable but low shift to higher frequencies is exhibited with increasing carbon loading. This effect is intensified in each case in the measurement 62 with two, and in the measurement 64 with three catalyst elements. An estimation of the loading of the catalyst elements with carbon, and therefore a measurement of the quantity of carbon-containing deposits in the microwave resonator, can thus be carried out from the measured resonant frequency.

FIGS. 6a and 6b show a cylinder resonator with circumferential surface and end faces made of a mesh.

FIGS. 6a and 6b illustrate a cylinder resonator 70. FIG. 6a shows the cylinder resonator 70 from the side, FIG. 6b from above. The outline of the cylinder resonator 70 is implemented in the form of a circle in the embodiment illustrated. Both the circumferential surface 22 and the two end faces 24 are implemented as mesh 26. The mesh 26 consists of an electrically conductive material; the quality of the cylinder resonator 70 is determined, amongst other things, by the thickness of the mesh, the porosity, the spacing of the holes, the diameter of the holes and the shape of the holes. The diameter of the holes should preferably be below one quarter of the wavelength of the microwave radiation used, so that the latter can as far as possible not penetrate through the mesh 26. In this regard, see, for example, T. Y. Otoshi “RF Properties of 64-m-Diameter Antenna Mesh Material as a Function of Frequency”, JPL Technical Report 32-1526, Vol. III.

Depending on whether the cylinder resonator 70 is to be operated in reflection or in transmission, one or two antennas are arranged in the cylinder resonator 70. Furthermore, for example, one of the end faces 24 can be implemented as a removable cover in order to be able to fill the interior of the cylinder resonator 70 with filling elements.

FIGS. 7a and 7b show a cylinder resonator with closed circumferential surface and covering surfaces made of a mesh.

FIGS. 7a and 7b illustrate a cylinder resonator 70. FIG. 7a shows the cylinder resonator 70 from the side, FIG. 7b in a view from above. The resonator illustrated represents an alternative embodiment to the resonator presented in FIGS. 1 and 2. The outline of the cylinder resonator 70 in the embodiment illustrated is implemented in the form of a circle. The circumferential surface 22 is generally produced from an electrically conductive material and has no openings. The two end faces 24 of the cylinder resonator 70 are implemented as mesh 26. The mesh 26 consists of an electrically conductive material. The characteristics of the mesh 26 have already been described further above. The microwave radiation can penetrate neither the electrically conductive mesh 26 nor the circumferential surface 22.

Once more, one or two antennas is/are arranged in the cylinder resonator 70, depending on whether the latter is operated in reflection or transmission. Furthermore, for example, one of the end faces 24 can be implemented as a removable cover in order to fill the interior of the cylinder resonator 70 with filling elements.

FIGS. 8a and 8b show a cylinder resonator with closed circumferential surface and a grid as covering surfaces.

FIGS. 8a and 8b illustrate a cylinder resonator 70. FIG. 8a shows the cylinder resonator 70 from the side, FIG. 8b in a view from above. The resonator illustrated represents an alternative embodiment to the resonator presented in FIGS. 1 and 2. The outline of the cylinder resonator 70 in the embodiment illustrated is implemented in the form of a circle. The circumferential surface 22 is generally produced from an electrically conductive material and has no openings. The two end faces 24 of the cylinder resonator 70 are implemented as a grid 28, an electrically conductive material likewise being used for the grid 28 and the bars of the grid 28 having a length d_{g}. In a way similar to the embodiments of the resonator already described, the dimensions of the openings in the grid 28 are chosen such that the microwave radiation cannot penetrate through the grid 28. In the case of an electrically conductive grid, the quality of the resonator is determined, amongst other things, by the number and arrangement of the grid bars and the length d_{g} of the grid. Suitable arrangements are, for example, two crossed grid bars (cross grid) or four grid bars with an angle of respectively 45° to one another (star grid). Further suitable grids and their characteristics can be gathered, for example, from the dissertation by E. G. Nyfors “Cylindrical Microwave Resonator Sensors for Measuring Materials Under Flow”, May 2000, ISBN 951-22-4983-9, pages 131 to 146.

Once more, one or two antennas are arranged in the cylinder resonator 70, depending on whether the latter is operated in reflection or transmission. Furthermore, for example, one of the end faces 24 can be implemented as a removable cover in order to fill the interior of the cylinder resonator 70 with filling elements.

FIGS. 9a and 9b show a cylinder resonator which tapers toward the open ends.

FIGS. 9a and 9b illustrate a cylinder resonator 70. FIG. 9a shows the cylinder resonator 70 from the side, FIG. 9b in a view from above. The resonator illustrated represents an alternative embodiment to the resonator presented in FIGS. 1 and 2. The cylinder resonator 70 has a circular shape in cross section, the diameter being constant in the central area 72. Starting from the central area 72, the cross section tapers toward the two ends 74. The circumferential surface 22 of the cylinder resonator 70 is generally produced from an electrically conductive material and has no openings, but the cylinder resonator is open at the tapered ends 74.

The diameter of the tapered ends 74 of the cylinder resonator 70 is preferably matched to the frequency of the microwaves used such that the frequency of the microwaves lies below the limiting frequency of the tapered parts of the cylinder resonator 70, and thus no onward transmission of the microwaves takes place.

FIGS. 10a and 10b show a coaxial resonator.

FIGS. 10a and 10b illustrate a coaxial resonator 71, in the interior of which a tube 78 is arranged coaxially with the circumferential surface 22 as an internal conductor. The resonator illustrated represents an alternative embodiment to the resonator presented in FIGS. 1 and 2. The tube 78 of the cylinder resonator 70 is held by webs 76, which preferably consist of a non-electrically conductive material. The tube 78 and the circumferential surface 22 are made of an electrically conductive material. FIG. 10a shows the coaxial resonator 71 from the side, FIG. 10b in a view from above. In the area around the tube 78, further microwave modes are able to propagate but cannot exist outside the area of the coaxial arrangement. The radiation thus remains limited to the interior of the resonator 71, as the following short examination shows:

The lowest resonance of the coaxial resonator 71, given a length Lᵣ of the internal conductor, is

λᵣ=2Lᵣ,

where λᵣ is the wavelength of the resonant microwave radiation. If the length of the internal conductor is chosen to be long enough, which means that Lᵣ is greater than 0.85D, where D is the diameter of the coaxial resonator 71, then the resonant frequency of the coaxial resonator 71 lies below the cut-off frequency of a cylindrical waveguide, the cut-off wavelength of which is given by 1.71 D. see for example the dissertation by E. G. Nyfors “Cylindrical Microwave Resonator Sensors for Measuring Materials Under Flow”, May 2000, ISBN 951-22-4983-9, pages 53 and 54.

FIGS. 11a and 11b show a cylinder resonator with electrically conductive fin.

FIGS. 11a and 11b illustrate a cylinder resonator 70, in the interior of which, starting from the circumferential surface 22 in the direction of the center, there is arranged a fin 80. FIG. 11a shows the cylinder resonator 70 from the side, FIG. 11b in a view from above. The resonator illustrated represents an alternative embodiment to the resonator presented in FIGS. 1 and 2. The fin 80 and the circumferential surface 22 are made of an electrically conductive material. In the area around the fin 80, further microwave modes are able to propagate but cannot exist outside this area. The radiation thus remains limited to the interior of the resonator. The cut-off frequency of the resonator depends on the height and length of the fin 80, this frequency being lower than that of the resonator without fin, see, for example, the dissertation by E. G. Nyfors “Cylindrical Microwave Resonator Sensors for Measuring Materials Under Flow”, May 2000, ISBN 951-22-4983-9, pages 85 to 87.

FIG. 12 illustrates for a reactor the activity of a catalyst in the form of a conversion rate 84 and a resonant frequency 82 in dependence on the operating time of the reactor in days. The reactor used here as an example is a reactor that is used for the hydration of acetylene, containing a hydrating catalyst. The conversion rate 84 is given in % and is a measure of the activity of the catalyst. The greater the conversion rate, the higher the activity of the catalyst. In the example illustrated in FIG. 12, acetylene is hydrated, so that the conversion rate 84 gives the proportion of hydrated acetylene. At the beginning, the conversion rate 84 is almost 99%, that is to say almost 99% of the acetylene is hydrated in the reactor. After operation of the reactor for 20 days, the activity of the catalyst has reduced to such an extent as a result of carbon deposits that the conversion rate 84 has fallen to about 87%.

During the operation of the reactor, microwave radiation was radiated into the reactor and detected again. The reactor serves here as a microwave resonator. The frequency of the microwave radiation was varied between 300 kHz and 20 GHz. A resonant frequency that is attributable to the catalyst bed contained in the reactor was found in the range around 9.75 GHz. At the beginning of the operation of the reactor, the resonant frequency 82 was about 9.75 GHz. As operation progresses, the catalyst changes, which has an effect on its dielectric properties. As a consequence, the resonant frequency 82 also changes. After 20 days of operation, the resonant frequency 82 has reduced to about 9.67 GHz.

The illustration of FIG. 12 reveals that the conversion rate 84 decreases approximately in proportion with the resonant frequency 82. The resonant frequency 82 is consequently a good indicator of the activity of the catalyst.

In FIG. 13, as in FIG. 12, the resonant frequency 82 is illustrated in dependence on the operating time of the reactor in days. Furthermore, in FIG. 13, a pressure drop 86 over the catalyst bed is plotted in bar.

As the illustration of FIG. 13 reveals, even after 20 days of operation the pressure drop 86 over the catalyst bed is still virtually unchanged. By contrast, there is already a clear displacement of the resonant frequency 82. The resonant frequency 82 is consequently much better suited as an indicator of the activity of the catalyst.

List of Designations

10 Container/reactor

12 Interior of container

14 Filling elements

16 Container rim

20 Microwave resonator

22 Circumferential surface

24 End face

26 Conductive mesh

28 Conductive grid

30 Antenna (first)

32 Antenna (second)

34 Mounting (non-conductive)

36 Interior of the microwave resonator 20

38 Antenna feed line

40 Analysis unit

42 Capillary

44 Granules

46 Diameter of the capillary 42

48 Diameter of the microwave resonator 20

50 Height of the microwave resonator 20

52 Coaxial cable

54 Inductive injection

60 Measurement with 1 granule

62 Measurement with 2 granules

64 Measurement with 3 granules

70 Cylinder resonator

71 Coaxial resonator

72 Central area

74 Ends

76 Web

78 Tube

80 Fin

d_{g} Length of the grid

82 Resonant frequency

84 Conversion rate

86 Pressure drop

1.-16. (canceled)

17. A method for measuring deposits in the interior of an apparatus by using microwave radiation, comprising the steps:
a. arranging at least one microwave resonator in the interior of the apparatus, wherein the interior of the microwave resonator is connected to the interior of the apparatus such that an exchange of material can take place,
b. introducing microwave radiation into the at least one microwave resonator and
c. determining a resonant frequency and/or a quality of a resonance of the at least one microwave resonator,
wherein the steps b) and c) are repeated and, from a change in the resonant frequency and/or the quality of a resonance of the at least one microwave resonator, conclusions are drawn about the quantity and/or type of deposits in the interior of the apparatus and wherein filling elements are arranged in the interior of the apparatus, wherein filling elements are likewise arranged in the interior of the at least one microwave resonator and wherein identical filling elements are used respectively and an identical filling of the filling elements is used, such that the same conditions are produced in the interior of the at least one microwave resonator as in the interior of the apparatus.

18. The method as claimed in claim 17, wherein the least one microwave resonator in the interior of the apparatus is designed and positioned so that fluid dynamics of the apparatus are not impaired.

19. The method as claimed in claim 17, wherein the filling elements comprise a catalyst material.

20. The method as claimed in claim 17, wherein, in step a), at least two microwave resonators are arranged distributed in the interior of the apparatus, and steps b) and c) are run through for a plurality of microwave resonators, wherein the distribution of the microwave resonators in the interior of the apparatus and the respective quantity and/or type of deposit determined are used to draw conclusions about the spatial distribution of the deposits in the apparatus.

21. The method as claimed in claim 17, wherein the apparatus is a column, a heat exchanger or a reactor.

22. A device for measuring deposits in the interior of an apparatus, comprising at least one microwave resonator, a microwave generator and an analysis unit, wherein the microwave resonator is designed such that, given an arrangement in the interior of the apparatus, an exchange of material between the interior of the microwave resonator and the interior of the apparatus can take place, and wherein the analysis unit is equipped to determine a resonant frequency and/or a quality of a resonance of the at least one microwave resonator and from this to draw conclusions about the quantity and/or type of deposits and wherein the interior of the apparatus is filled with filling elements, wherein filling elements are likewise arranged in the interior of the at least one microwave resonator, wherein the respective filling elements are identical and have an identical filling, such that the same conditions exist in the interior of the at least one microwave resonator as in the interior of the apparatus.

23. The device as claimed in claim 22, wherein the wall of the microwave resonator is built up at least partly from an electrically conductive grid or an electrically conductive mesh.

24. The device as claimed in claim 22, wherein the at least one microwave resonator is designed as
a cylinder resonator with circumferential surface and end faces made of an electrically conductive mesh or grid,
as a cylinder resonator with a closed electrically conductive circumferential surface and end faces made of an electrically conductive mesh or grid,
as a cylinder resonator with conically tapering ends, as a coaxial resonator or
as a cylindrical resonator with electrically conductive fin.

25. The device as claimed in claim 22, wherein the filling elements comprise a catalyst material.

26. The device as claimed in claim 22, wherein the device comprises at least two microwave resonators, which can be arranged distributed in the apparatus, wherein the analysis unit is equipped to use the respective type and/or quantity of the deposits determined and the distribution of the microwave resonators to draw conclusions about the distribution of the deposits in the interior of the apparatus.

27. The device as claimed in claim 22, wherein the apparatus is a column, a heat exchanger or a reactor.
